(19) United States
(12) Patent Application Publication
(10) Pub. No.: US 2013/0268451 A1
(43) Pub. Date: Oct. 10, 2013

(54) Method and System for Assessing the Candidacy of an Applicant

(71) Applicants: Vijay Pendyala, Castro Valley, CA (US); Leslie Stretch, Danville, CA (US)

(72) Inventors: Vijay Pendyala, Castro Valley, CA (US); Leslie Stretch, Danville, CA (US)

(73) Assignee: Callidus Software Incorporated, Pleasanton, CA (US)

(21) Appl. No.: 13/406,163

(22) Filed: Feb. 27, 2012

Related U.S. Application Data
(60) Provisional application No. 61/546,438, filed on Oct. 12, 2011.
(60) Provisional application No. 61/586,613, filed on Jan. 13, 2012.

(51) Int. Cl. G06Q 10/10

(52) U.S. Cl. CPC G06Q 10/1053
USPC 705/321

(57) ABSTRACT

A method and apparatus for automating the process of assessing a candidate and confidentially determining whether the candidate is suited for a particular job opening is disclosed. A designated user creates a position to be filled and establishes the requirements and qualifications for that position. As the candidate applies to a particular position, a computer system collects application data from the candidate in a variety of formats and outputs the application data in a uniform manner to allow comparison of multiple candidates applying for the same job opening. The designated user also shares the collected application data with a plurality of secondary users. The secondary users browse the application data, rate the candidates and provide feedback to the designated user. The designated user is able to determine which candidate to extend employment to, after having viewed the application data, as well as the feedback and ratings provided from the secondary users.

### CROSS-REFERENCE TO RELATED APPLICATION

This application claims the benefit of provisional Patent Application Ser. No. 61/546,438, filed Oct. 15, 2011, and provisional Patent Application Ser. No. 61/586,613 filed Jan. 13, 2012, both applications are assigned to the assignee of the present application, and incorporated herein by reference.

### FIELD OF THE INVENTION

The present invention relates generally to employment recruiting, and more specifically to streamlining the recruiting process for both the candidate and the employer while selecting the best-suited candidate available for a particular position within an organization.

### RELATED ART

In the recruiting world, companies usually expend a considerable amount of money and resources to identify and hire the ideal employee. Using a conventional approach, recruiters or hiring managers become directly involved in the process as they interview multiple candidates. However, as more individuals participate in the interviews, greater variation is introduced into the interviewing process which often leads to inconsistency in the assessment of candidates. Another concern using this approach is the high cost of travel associated with meeting candidates from multiple locations in addition to the costs associated with lost productivity from time spent away from other tasks.

One popular technique which seeks to address these issues in recruiting is the use of assessment tests and extensive questionnaires. A company will often hire consultants to uniquely tailor these tests and questionnaires to suit the specific culture and needs of a particular organization. However, in spite of how well drafted and designed these tests are, they have been shown to provide a largely objective assessment of a candidate's skills and qualifications, with little or no regard for a candidate's demeanor or personality (i.e., subjective attributes).

Another common recruiting technique that attempts to address the above shortcomings is the use of remote connectivity technologies (such as Skype, Google Talk, iChat, etc.) during the interviewing process in order to increase the level of interaction with a potential candidate. However, this approach often involves the use of one centralized individual—usually a recruiter, staffer, or hiring manager who conducts the remote interview using some type of video or audio interface, and at the conclusion of the interview, this individual attempts to communicate his or her impression of the candidate with other team members. When sharing such information with other team members, valuable information about the candidate's subjective qualities (personality, demeanor, attitude, etc.) is often lost in the communication process.

Accordingly, what is needed is a method and system for better assessing a remote potential candidate measuring the candidate's likelihood of success and performance within an established organization.

### SUMMARY OF THE INVENTION

The present invention provides a better solution to address these problems, and as such delivers a system and method for assessing an applicant's candidacy using a web-based platform on a cloud-based server. Also, the present method is described as providing a job description by the hosted application for a position for said candidates to review and provide appropriate responses thereto; and combining by the hosted application multiple files including an uploaded video response file, and one or more reviewer files containing feedback, ratings, and response data into a single frame of the GUI of the hosted application.

One advantage of a system and method in accordance with the present invention is the ability to rapidly interview job candidates over the web anytime, anywhere.

A second advantage of a system and method in accordance with the present invention is that the combination of online video interviewing and assessment testing enables managers to rapidly evaluate candidates based on identified strengths and weaknesses, while determining a candidate's suitability for a particular role.

A third advantage of a system and method in accordance with the present invention is the ability to instantly share the details of a candidate's profile with multiple stakeholders without travel costs, scheduling conflicts or lost productivity.

### BRIEF DESCRIPTION OF THE DRAWINGS

FIG. 1 is a block diagram of a candidate assessment system is shown in accordance with a preferred embodiment of the present invention.

FIG. 2 illustrates the registration process for a new job candidate.

FIG. 3a illustrates a flowchart of a user creating a position and beginning the application process.

FIG. 3b illustrates sample pre-selection questions.

FIG. 3c illustrates a completed job posting with pre-selection questions and job description.

FIG. 3d represents a screen shot of a company webpage.

FIG. 3e is an illustration of an integrated module of the pre-selection process.

FIG. 3f is an illustration of a screenshot that a candidate will view when prompted to complete video interview questions.

FIG. 3g is an illustration of an integrated module used in the formal application process.

FIG. 4 depicts further details of the step where a candidate uses a video system to provide a video response to interview questions.

FIGS. 5a-5b illustrate a video system which a candidate may use to capture and record video.

FIG. 6a depicts further details of the step where the candidate's written and audio responses are shared amongst designated users.

FIG. 6b is an illustration of a screenshot where a user may compare and contrast candidates.

FIG. 6c illustrates a screen shot of what a designated user will see when viewing details of a candidate's assessment.

FIG. 6d illustrates an overview of an integrated module which incorporates feedback from reviewers.

FIG. 7a is a screen shot which further depicts step the step where a graphical user interface where an administrator creates a job posting.

FIG. 7b depicts a screenshot where a user logs in to the assessment tool.

FIG. 8 illustrates a screen shot of an integrated module which designated users will view.

### DETAILED DESCRIPTION

The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

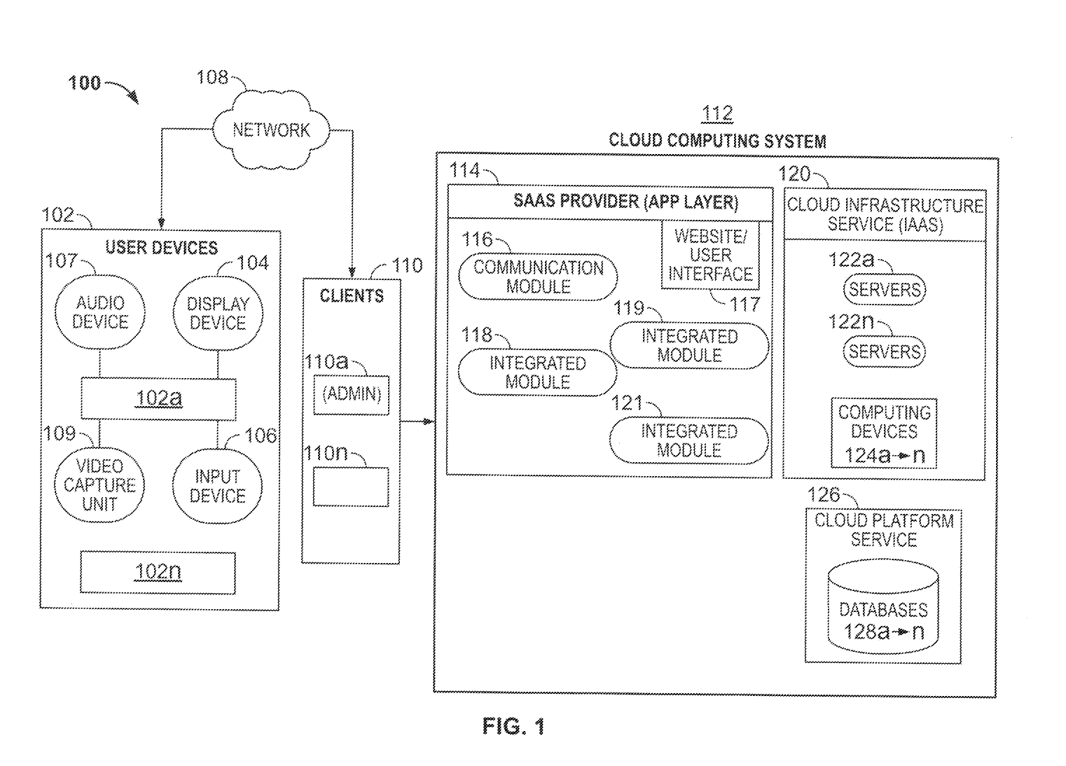

With reference to FIG. 1, a block diagram of a candidate assessment system is shown in accordance with a preferred embodiment of the present invention. The candidate assessment system 100 includes one or more user devices 102 which communicate with a cloud computing system 110 via network 108. Network 106 may include one or more type of network including the Internet, a Wi-Fi network, a wide-area network, a local area network, a peer-to-peer network, a virtual private network, a cellular network, a Bluetooth® network, etc. or any other type of interconnect capable of sending data from one device to another. The one or more user devices 102 include a first user device 102a, and an nth user device 102n, and may comprise a desktop computer, a laptop computer, a tablet device (such as an iPad®), a smartphone, a cellular telephone, or a combination thereof. The one or more user devices 102 may be associated with the same or different users. For example, user device 102a may be associated with an employer-administrator and user device 102b may be associated with a candidate. The one or more user devices 102 each contain appropriate software to enable each user device 102 to communicate with each other via a network 108. The one or more user devices 102 each comprise a display device 104 (such as a computer monitor or display screen) and an input device 106 (such as a touch pad, or keypad) which enable users to view, input, and send information via the network 108 to other user devices 102. In addition, user devices 102 may also communicate with cloud computing system 112 using a network 108 and one or more clients 110.

Cloud computing system 112 is a multi-tenant infrastructure wherein one or more computational resources (not shown) are accessible over network 108 to provide users with on-demand computing services. Cloud computing system 112 may include a SAAS provider 114, a communication module 116, integrated modules 118-119, and 121, cloud infrastructure service 120, and cloud platform service 126. One or more clients 110 include a first client 110a, . . . and an nth client 110n. The one or more clients 110 each transmit information to SAAS provider 114, and receive information from SAAS provider 114 via communication module 116 and network 108. Integrated modules 118, 119, and 121 are individual self-contained components each containing an aggregation of information which correlate with various parts of the application process. Integrated module 118 is associated with the preselection process. Integrated module 119 is associated with the formal candidacy process. Integrated module 121 is associated with the review portion of the candidacy process where reviewers provide feedback on candidates in the form of comments and ratings. Each of the integrated modules 118, 119, and 121 correlate to three separate web pages (discussed in further detail below). Each web page is a master web page which has been created by a master jsp file. Within each master jsp me are smaller jsp files which are aggregated with the master web page to create the finished composite web page which is visible to the user (discussed in further detail below). Cloud infrastructure service 120 comprises one or more servers 122. The one or more servers 122 may further include one or more computing devices 124a, . . . , 124n which may comprise a desktop computer, a laptop computer, or otherwise similar devices. Cloud platform service 126 comprises one or more databases 128. The one or more databases 128 include a first database 128a and an nth database 128n. The components of cloud computing system 112 may be implemented in a single computing device or a plurality of computing devices in a single location, in a single facility, and/or may be remote from one another in a plurality of locations.

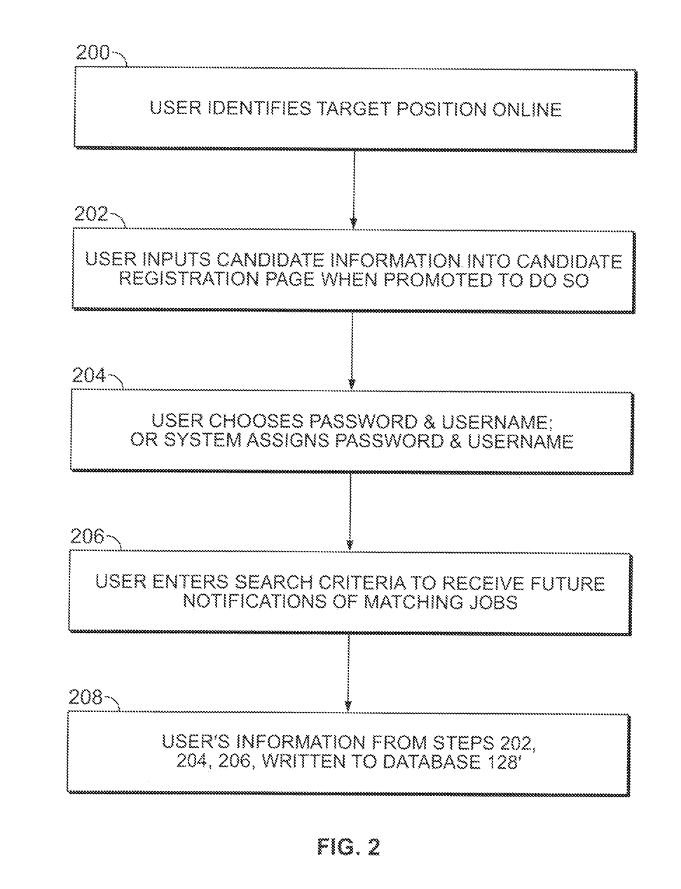

FIG. 2 illustrates the registration process for a job candidate. Beginning with step 200, using display device 104′ of user device 102′, a user identifies a target position online (via a company website, Internet job board, or after receiving an email notification from SAAS provider 114′). Next, in step 202, using the input device 106′ of user device 102′, the user enters required candidate data 18 such as first and last name, home address, email address and a username. The candidate data 18 is transmitted to SAAS provider 114′ via client 110′. In step 204, a user either selects a password that meets the system requirements in terms of length, character type, symbols, etc., or, using SAAS provider 114′, the system may automatically assign such a password to the user, and send the user a notification of the system-assigned password via client 110′. In step 206, SAAS provider 114′ prompts the user to enter search criteria in order to receive future notifications when matching opportunities become available. The user may check a box indicating a desire to receive such notifications, or may leave the box unchecked if they do not wish to receive such notifications. Examples of search criteria may include desired lob location, desired salary, desired field (e.g. accounting, engineering), etc. Next, in step 208, the user's candidate data 18 (from step 202), username and password (from step 204), and search criteria (from step 206) is written and saved to database 128′.

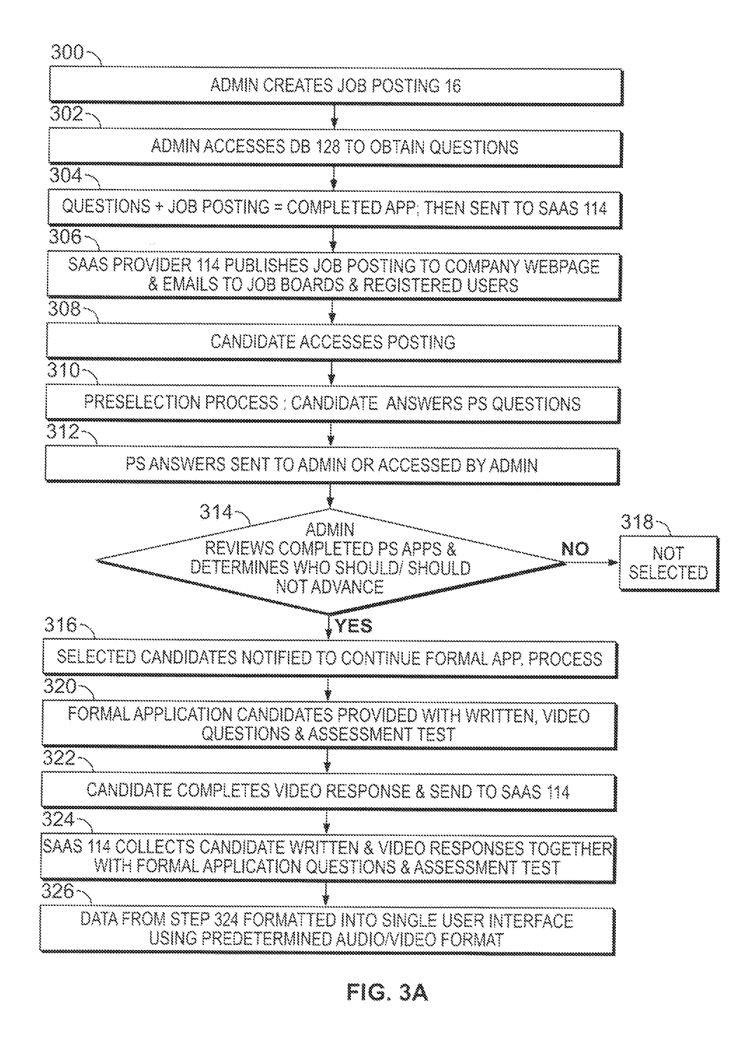

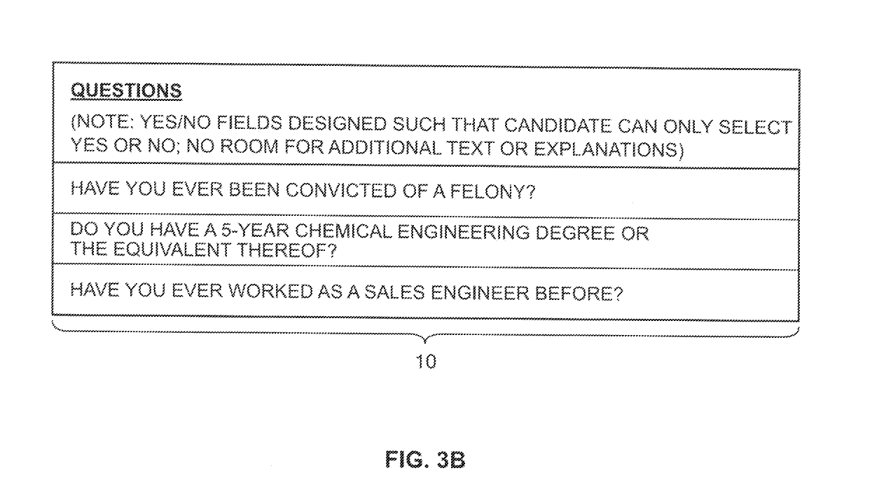

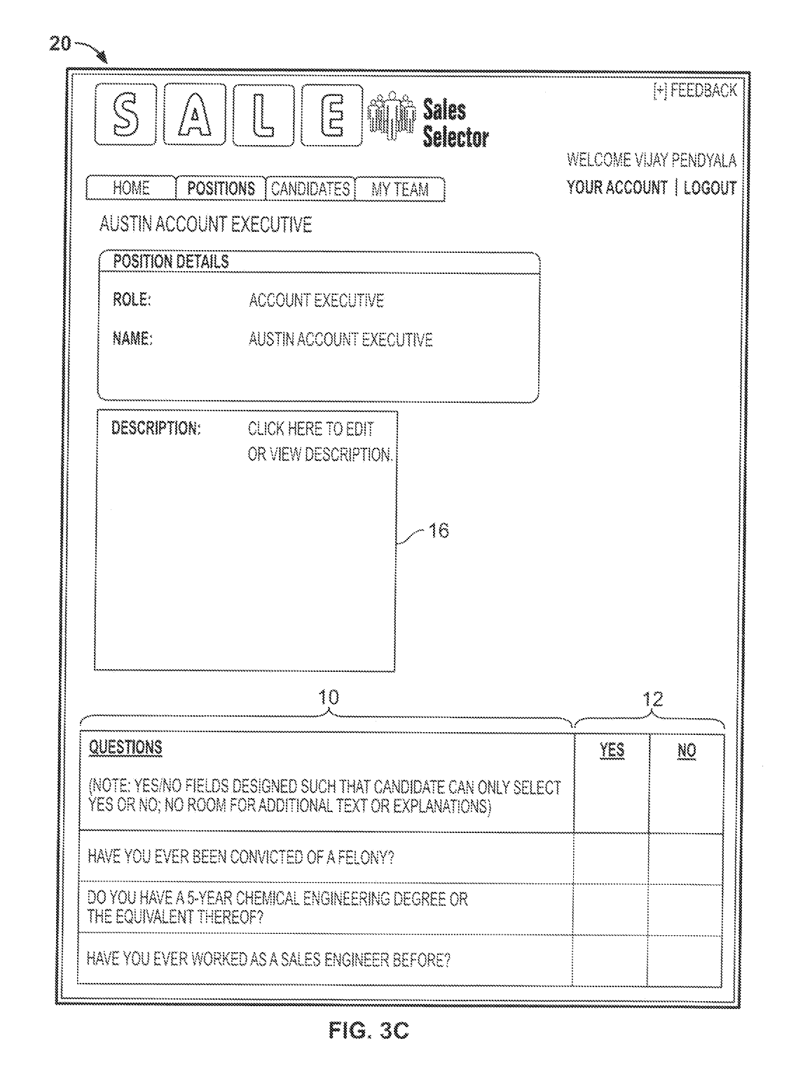

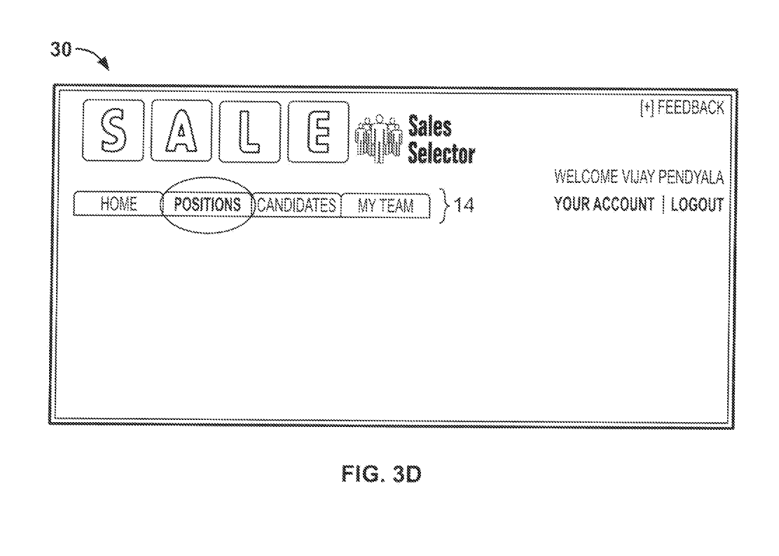

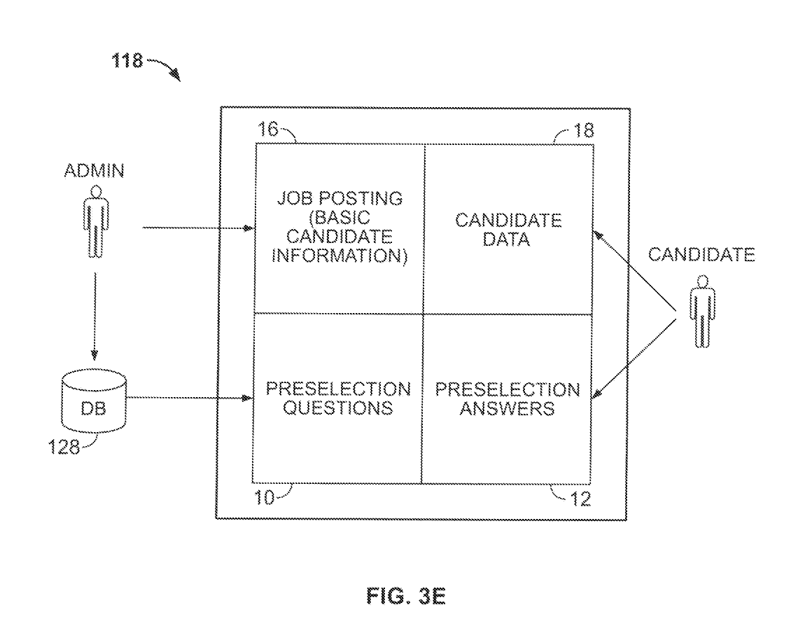

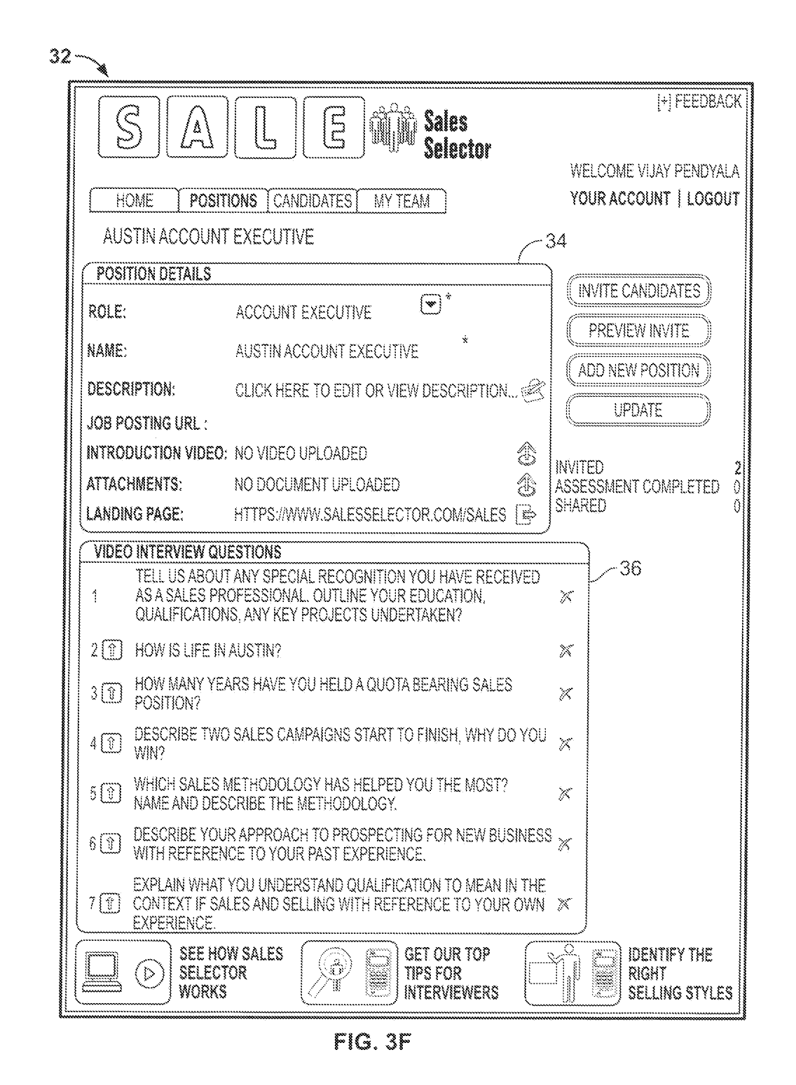

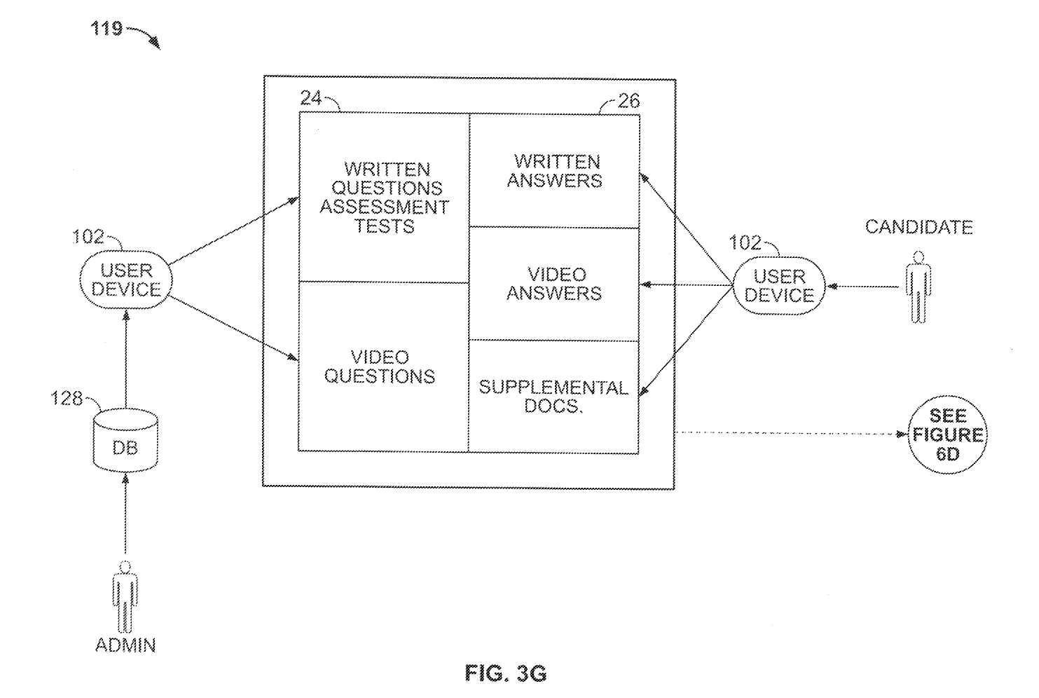

FIG. 3a illustrates a flowchart of a user creating a job posting 16 and beginning the application process. Beginning with step 300, an administrator accesses a webpage using a graphical user interface based web browser (such as Google Chrome®, Mozilla FireFox® or Internet Explorer® (in either HTML or XHTML format) via the display device 104′ of user computing device 102′ in order to create a job posting 16. The user computing device 102′ accesses a web page via network 108′ which allows access to SAAS provider 114′ via client 110′. The administrator then has a choice as to how to create the job posting 16. In one embodiment, the administrator manually creates a job posting 16 by entering a job title, a description of the required education, a description of the required experience, and a description of the responsibilities required of the position. The administrator enters this information via input device 106′ of user computing device 102′. Client 110′ sends the job posting 16 to SAAS provider 114′ via communication module 116′. SAAS provider 114′ then uploads job posting 16 to website/user interface 117′. In a second embodiment, the administrator accesses a database 128′ which contains multiple types of prior developed templates for job descriptions, and contains information such as required education, and a description of responsibilities of the position. In this embodiment, the administrator is free to select a prior-developed template, and has the option of modifying the prior-developed template as desired. In addition to selecting a prior developed template, the administrator may also use a template wizard to quickly and easily create a template.

In step 302, an administrator accesses database 128′ via client 110′ in order to obtain a list of questions. The questions may comprise a group known as pre-selection questions 10. As illustrated in FIG. 3b, pre-selection questions 10′ include a list of previously written questions designed to “screen out” or eliminate those candidates who do not fulfill the minimum basic criteria set forth by the administrator. The pre-selection questions 10′ are generally of a “yes/no” format, and are added to the job posting 16′ in step 304.

FIG. 3c is an illustration of screen shot 20, which includes both pre-selection questions 10′ and job posting 16′, and represents the page that a candidate will view when completing the pre-selection process. Job posting 16′ may be stored within the web server's file system as a static text HTML file since the viewer will need to read it. Pre-selection questions 10′ may be stored in a DHTML file format, since the viewer must interact with the webpage assessment tool by reading the questions and responding by selecting either a “yes” option or a “no” option. Hence, since a webpage may consist of numerous HTML files, the source code may be programmed to permit both files to be displayed within a single user interface, or may instead allow for a hyperlink to connect the two files from more than one page. Communication module 116′ then sends job posting 16′, pre-selection questions 10′, and pre-selection answers 12 to SAAS provider 114′. Next, in step 306, SAAS provider 114′ publishes the completed job posting 16′ to the appropriate portion (“career section” or “positions available”) of the company homepage, as depicted in FIG. 3b.

FIG. 3d represents a screen shot 30 of a company webpage. Most often, from a company home page, a navigation bar 14 is typically available and may help a candidate locate posted positions. “Employment opportunities”, “join us”, and “career”, are common names or indicators which can be easily located on a company homepage in order to guide a candidate to a job source or portal. SAAS provider 114′ emails the completed job posting 16′ to candidates who registered in advance to receive such notification emails (discussed above in step 206) as well as job board websites (such as Monster.com, Simply Hired, etc.) which are also enabled to receive such job posting notifications. Candidates typically arrange to receive such notifications by visiting one of the above-mentioned websites, creating a registration and username, and checking a box indicating a desire to receive such notifications. Job board-type websites are typically enabled to receive such notifications of newly-posted positions when a user creates an account with the job board, and agrees to send such notifications to the job board as they become available.

In step 308, a candidate enables user device 102′ to access job posting 16′ created by the administrator. There are numerous ways for a candidate to access job posting 16′. First, a candidate may locate the posted position on a company website by accessing the company website and performing a search of available positions. Second, a candidate may locate the posted position via an internet job board (such as Monster.com, Simply Hired, etc.) after entering particular search criteria, or after having received email alerts from the job board that a particular position may be a suitable match for the candidate. A third approach, by which a candidate may locate a position is where the candidate is invited to apply to the position by the company. In this instance SAAS provider 114′ retrieves the candidate's information stored in database 128′ from when the user registered and agreed to receive email notifications when positions matching the candidate's criteria become available (discussed above in step 208). SAAS provider 114′ sends an email to the candidate via communication module 116′, indicating that a position matching the candidate's criteria is available for application. Regardless of how a candidate discovers the position, the candidate engages user device 102′ to access job posting 16′, and views job posting 16′ via display device 104′.

Step 310 begins what is known as the pre-selection process. In the preselection process, the candidate is required to complete and submit answers to preselection questions 10′. The candidate completes the pre-selection questions 10′ using input device 106′ of user device 102.′ In step 312, a candidate responds to the preselection questions 10′ which are sent to SAAS provider 114′ via client 110′, and the responses are known as pre-selection answers 12′.

As illustrated in FIG. 3e, SAAS provider 114′ creates an integrated module 118′. Integrated module 118′ is a self-contained component which contains an aggregation of information specific to the pre-selection portion of the application process. More specifically, the integrated module 118′ is comprised of a master web page created by a master jsp file. Within the master jsp file are smaller jsp files which are aggregated with the master web page to create the finished composite webpage which is visible to the user (FIG. 3c). Pre-selection questions 10′, pre-selection answers 12′, and job posting 16′ each represent smaller individual jsp files, each of which are aggregated within finished composite web page 20′. In a preferred embodiment, an administrator enters a job posting 16′ which details the requirements of a position and requires basic information from a candidate, candidate data 18 (i.e. name, address, email address). Next, as discussed above (steps 302-304), an administrator obtains pre-selection questions 10′ which will be used to help identify the most suitable candidates. Finally, the candidate enters responses to the requested candidate data, and the pre-selection answers 12′. Communication module 116′ sends integrated module 118′ to the administrator via client 110′. An administrator enables user device 102′ to retrieve the integrated module 118′, and is therefore able to view the electronic application and pre-selection answers 12′ via display device 104′ of user device 102′. In another embodiment, SAAS provider 114′ may email the integrated module 118′ to the administrator.

In step 314, an administrator accesses the pre-selection answers 12′ to the preselection questions 10′ located at SAAS provider 114′ via client 110′ by viewing integrated module 118′. An administrator views the pre-selection answers 12′ to the pre-selection questions 10′ via the display device 104′ of user device 102′. After viewing the electronic application and pre-selection questions 10′, an administrator decides which applicants shall continue the candidacy process, and which applicants shall not. In step 316, for those applicants selected to continue, an administrator sends a response of “yes” to SAAS provider 114′ via client 110′. After receiving the “yes” responses, the SAAS provider 114′ notifies the candidate to continue, by sending an email to each candidate. SAAS provider 114′ obtains the candidate's email address during the candidate registration process (discussed above in FIG. 2, steps 202-206). In step 318, for those applicants who will not continue, a “rejection letter” is sent to the applicant. In this instance, administrator sends a response of “no” to SAAS provider 114′ via client 110′. After receiving the “no” responses, SAAS provider 114′ obtains a “rejection letter” template from database 128′. Using the candidate data 18′ (provided by the candidate in step 202) SAAS provider 114′ completes missing fields in the rejection letter, such as a candidate's name, address, etc. and then emails the completed rejection letter to each candidate who will not advance within the candidacy process.

Next, in step 320, candidates who were invited to continue the candidacy process will begin the formal application process. In the formal application process, a candidate must provide answers to required information using a job submission. The required information may take the form of blank fields which need to be completed (i.e. and electronic application), or may consist of questions that need to be answered by the candidate. The questions may be of a “yes/no” format where the user must select an answer of either yes or no. In addition, the questions may require a “short answer” format in which a candidate may enter a limited about of text in response to a question. In addition to questions which require answers, the job submission process may allow for supplemental documents to be submitted by the candidate (resume, cover letter, recommendation letter, etc.). In this instance, a candidate may use input device 106′ of user device 102′ to attach supplemental documents. The completed job submission (including the optional supplemental documents) is then sent to SAAS provider 114′ via client 110′. In addition to answering required questions and submitting documents, a candidate may be asked to capture video of responses to interview questions in a compatible video format

FIG. 3f is an illustration of a screenshot 32 which a user will view when prompted to complete video interview questions of the formal application process. Block 34, entitled “position details” includes the specific information available to a candidate regarding a particular position. In addition to providing the name and detailed description of a position, block 34 provides an overall status summary of the candidate's progress. Included in the status summary are indicators for whether or not the candidate has uploaded a video, and another status indicator for whether or not a candidate has uploaded any attachment documents. Block 36, contains a list of questions which the candidate is required to answer in a video response format. Each question is flanked by status indicators that show whether a candidate has completed and uploaded a particular question. Next, in step 322, a candidate may utilize user device 102′ to create a video response by answering the required video questions in video format. The completed video file is then sent to SAAS provider 114′ via client 110′. Next, in step 324, SAAS provider 114′ forms integrated module 119′ by combining the written responses of the candidate's electronic application together with video response from the candidate as shown in FIG. 3f. Integrated module 119′ is a self-contained component which contains an aggregation of information specific to the formal candidacy portion of the application process. More specifically, the integrated module 119′ is comprised of a master web page created by a master jsp file. Within the master jsp file are smaller jsp files which are aggregated with the master web page to create the finished composite webpage which is visible to the user (not shown). In addition to the written and video responses, integrated module 119′ may also include supplemental documents that a candidate may wish to attach such as resumes, cover letters, transcripts, recommendation letters, or the like. A candidate may upload any such combination of documents, up to a maximum of 5 MB.

FIG. 3g is an illustration of integrated module 119′, which is used in the formal application process. Integrated module 119′ contains two portals—administrative portal 24 and candidate portal 26. Administrative portal 24 and candidate portal 26 are each created by smaller jsp files which are integrated into a larger composite web page (not shown) using a master jsp file. Administrative portal 24 contains the information provided by an administrative user such as the employer, Administrative portal 24 contains all questions and information sought from a candidate including, but not limited to written and video questions, and assessment tests. Candidate portal 26 contains all responses and information provided by a candidate user, including, but not limited to written responses to questions, responses to assessment tests, video responses, and optional supplemental documents which a candidate may wish to include in the application process. User device 102′ enables an administrator to obtain written questions, assessment tests, and video questions from database 128′, which is then stored in administrative portal 24. SAAS provider 114′ uploads the contents of administrative portal 24 to a graphical user interface. SAAS provider 114′ then sends an email notification to candidates that the formal application is available and ready. With user device 102′, candidates then provide written answers to questions and assessment tests, a video file containing video and audio responses, and any supplemental documents desired. The candidate's responses, video file, and supplemental documents are saved to a candidate portal 26. SAAS provider 114′ then uploads the content of candidate portal 26 to a graphical user interface. Administrative portal 24 and candidate portal 26 are collectively known as integrated module 119′. In step 326, integrated module 119′ is then formatted into a predetermined audio and video format to enable uniform comparison of multiple candidates using a single graphical user interface.

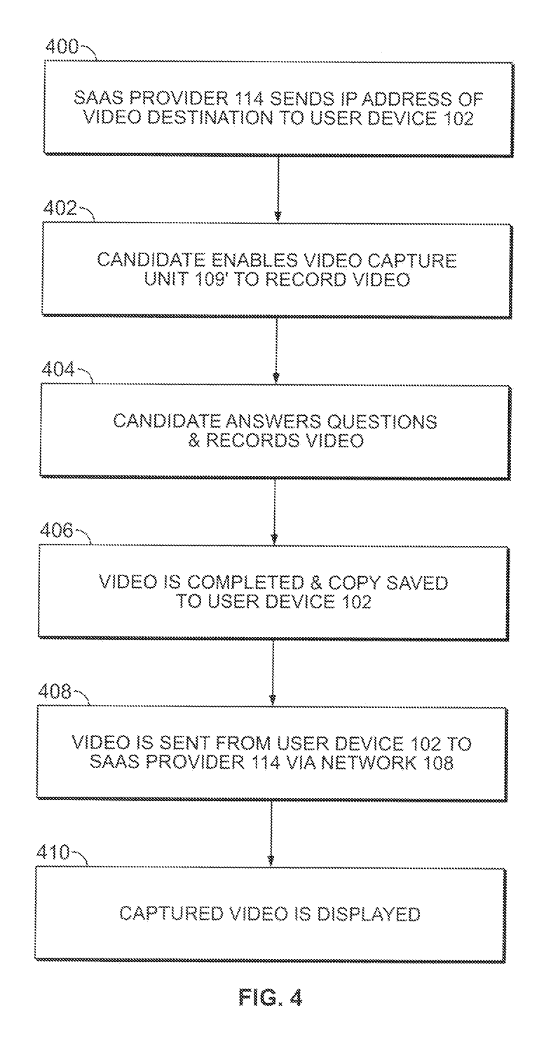

FIG. 4 depicts further details of step 322 where a candidate uses a video system to provide a video response to interview questions. Below is an example of the initial instructions that a candidate will see prior to beginning the video upload process:

Please review video upload instructions:
What formats of video files can be uploaded?
We support thousands of video/codec/container combinations (both decoding and encoding) including the usual suspects: H.264, VP6 FLV, MP4, MPEG, MPEG2, 3GP, 3GP2, AVI, VOB, WMV, etc.
What browsers are recommended to upload?
   Mozilla Firefox 6+
   Internet Explorer 7+
I cannot upload a video.
Depending on your connection speed and the size of the video, it can take anywhere from a few minutes to several hours to upload a video, Generally, if you have a high-speed Internet connection you can expect the upload to take somewhere between 1-5 minutes for every 1 MB, However, the experience is different for every user because of the variation in connection speeds, here are some tips:
   Make sure your video is in a supported format. We strongly recommend MP4 format.
   Please ensure that your recording time is 5 minutes or less and the video file size is 30 MB or less
   Check that you're using the latest version of a supported browser.
Uploading a video shouldn't take more than a few hours. If you're still having issues, please contact us.

Beginning with step 400, an IP address of the target video destination is provided to user device 102′ from SAAS provider 114′ via client 110′. In step 402, a candidate enables the video capture unit 109′ to record video. In step 404, a candidate may speak responses into an interface of video capture unit 109′ to the provided questions as the video capture unit 109′ records the responses including both audio and video. In step 406, once the candidate has concluded the video, the video capture unit 109′ is disabled and the recording is stopped. Depending on the type of user device 102′ being utilized by the user, a copy of the captured video may be saved to the hard drive (or other suitable location) of user device 102′. Next, in step 408, the captured video is sent from video capture unit 109′ to SAAS provider 114′ via network 108′. The following is an exemplary fragment of javascript which instantiates an upload of the captured video from the video capture unit to a SAAS provider is shown below:

data = uploadedFile.getBytes( );
fileName= uploadedFile.getName( );
fileName= uploadedFile.getOriginalFilename( );
extension= fileName.substring(fileName.lastlndexOf(“.”)+1);
contentType = uploadedFile.getContentType( );
sizeInBytes = uploadedFile.getSize( );
}else{
logger.info(“There is no file selected for upload”);

The actual upload using the Amazon® S3 storage server is shown below:

s3Service.putObject(testBucket, fileObject);

Prior to being uploaded, the file type and size are verified to ensure file has a video format. No other file types (i.e. word, text, pdf) may be uploaded by the system. The maximum size of each uploaded file is 30 MB. The following preliminary step used to verify the file type is a video file and is later used in order to transpose the file type into a consistent format for future use:

uploadVideoDTO.setType(“image”);

}else if(contentType.contains(“video”)){

if(fileType !=null && fileType != “”)

uploadVideoDTO.setType(“video”);

else

uploadVideoDTO.setType(“ additional_ video”);

}else if( contentType.contains(“ pdf”)){

uploadVideoDTO.setType(“pdf”);

}else if( contentType.contains(“text”)){
uploadVideoDTO.setType(“text”);

The uploaded video will be sent to database 128′ of cloud computing system 112′ via network 108′. In an exemplary embodiment of the present invention, the Amazon® S3 storage server is a type of a cloud computing system 112′ that is used. The following is an example of code may be used to connect to Amazon® S3 (or an otherwise similar cloud computing storage service):

//connect to s3 service.

S3Service s3Service = s3ServiceSSLN.connectToAmazonS3( );

Access permission (to access the uploaded video files located on the server) may also be established. The following code is an example of code which may be used to establish permission to access the s3 (or otherwise similar) server:

s3ServiceSSLN.grantPublicReadPermissionsToFile(s3Service,testBucket,
file Object);
uploadVideoDTO.setPath(DOCUMENTS_BUCKET_URL+fileName+
“.”+extension);

}
//update path( unique constraint) with attachmentSeq to it.

uploadVideoDTO =
uploadVideoService.updateAttachment(uploadVideoDTO);

In a preferred embodiment of the present invention, QuickTime® (by Apple® Inc.) is a multimedia player which is used to display captured video. Because QuickTime® utilizes an mp4 format, the uploaded captured video must be converted or encoded to such a compatible format One way to create such a compatible format is through the use of an encoding service such as Encoding.com. In the present invention, Encoding.com obtains permission to encode the video files from the Amazon® s3 server. Once permission is received and the encoding is completed, the newly encoded video file (now in mp4 format) is returned to the Amazon® s3 server. The following code is an example of how permission may be granted to perform encoding:

//grant permission to encoding.

s3ServiceSSLN.grantPermissionsToEncoding(s3Service,testBucket,

fileObject);

Next, in step 410, the captured video is displayed using display device 104′. The following is an exemplary fragment of javascript which displays the captured video and sets the parameters of ‘480’ width and ‘297’ height in order to fit into a single frame which may later be displayed by QuickTime® (or other multimedia player):

WlDTH=‘480’ HElGHT=‘297’ AUTOPLAY=‘false’ CONTROLLER=
‘true’ SCALE=‘ToFit’>
</EMBED>‘’);
if (navigator.userAgent.indexOf(“Firefox”)==−1)

document.write(“<video SRC=‘${signedVideoURL}’
TYPE=‘image/x-macpaint’

PLUGINSPAGE=‘https://www.apple .com/quicktime/ download’
QTSRC=‘${signedVideoURL}’
WIDTH=‘480’ HElGHT=‘297’ SCALE=‘ToFit’
controls=‘true’></video>”);
</script>
</OBJECT>

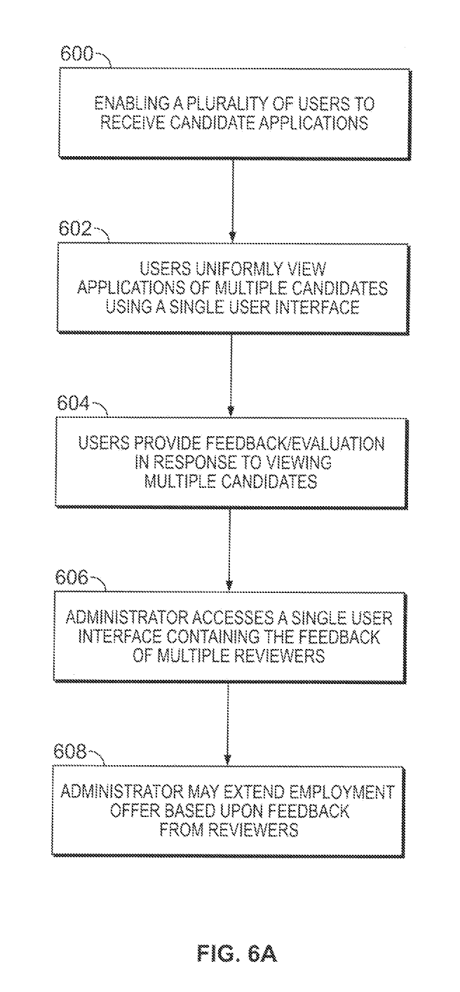

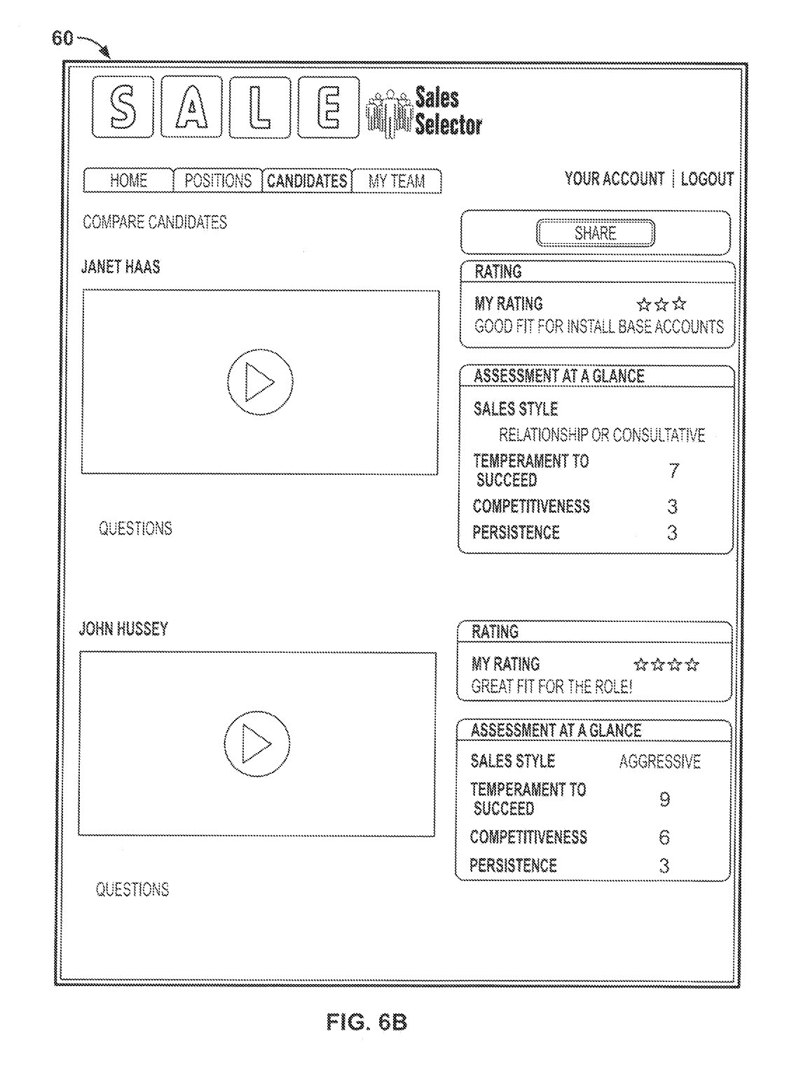

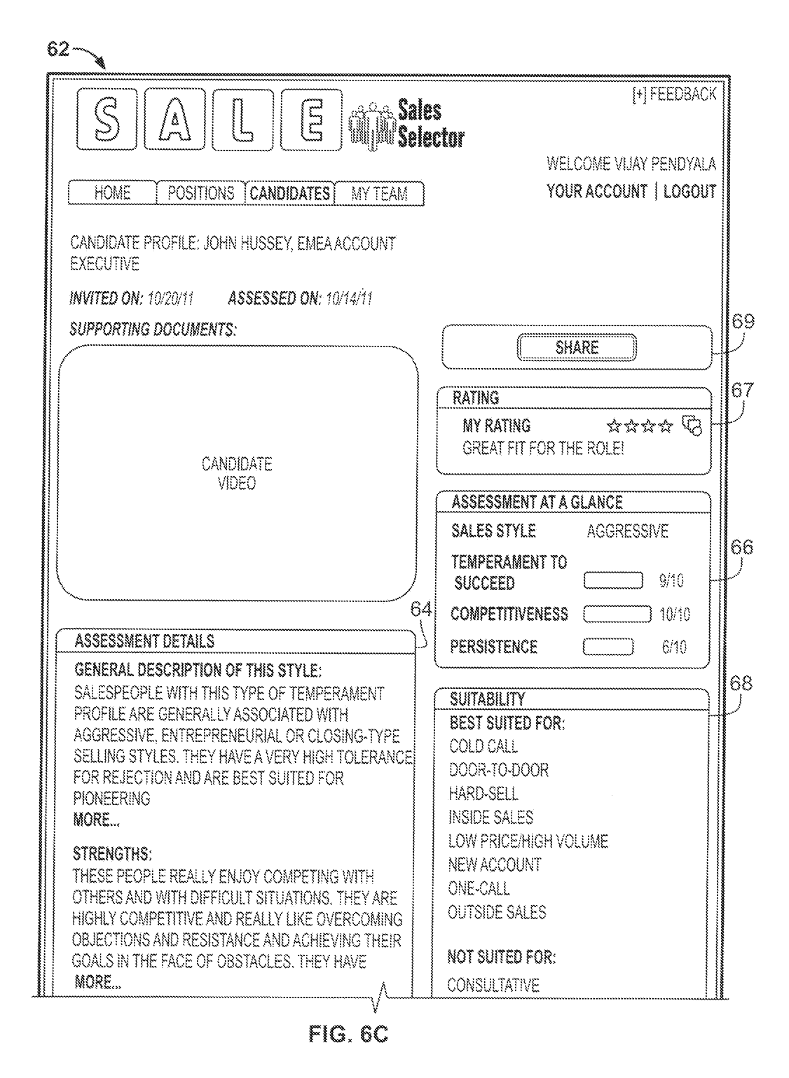

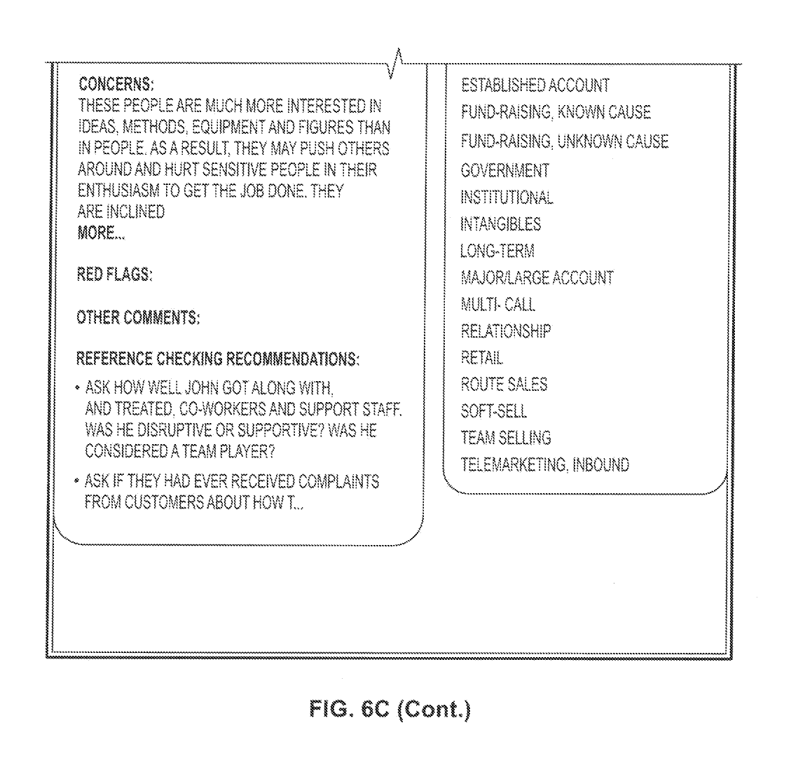

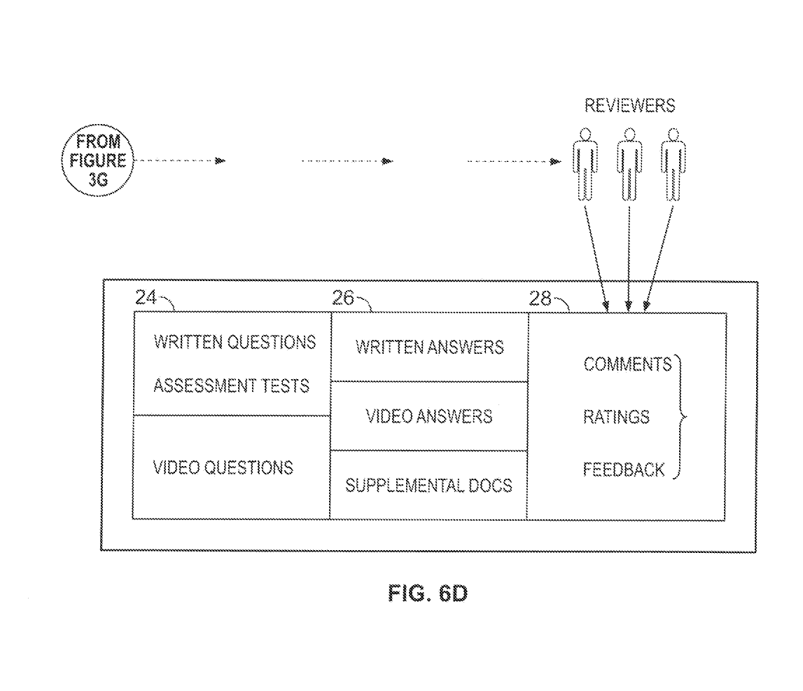

As discussed further in FIG. 6a, uploaded video may be shared with other viewers who have permission to retrieve and view such files from Amazon® s3. The following code is an example of how uploaded video files may be shared amongst other viewers. More specifically, a URL is tagged to a video through the use of a candidate ID and a position I D. The tagged video/URL is then shared with viewers:

var cid = document.getElementById(candidateId’).value;
var pid = document.getElementById(‘positionId’).value;
$(“#share”).load(“share.htm?action=view&pid=”+pid+“&cid=”+cid);
$(“#performanceCompare”).load(“ ../../common/
performanceComparison.jsp”);
$(‘#rateBtn’).click(function( ) {
var cid = document.getElementById(‘candidateId’).value;

var pid = document.getElementById(‘positionId’).value;
$(“#rate”).load(“rateCandidate.htm?cid=”+cid+“&pid=”+pid);

Video upload systems and methods, or certain aspects or portions thereof, may take the form of a program code (i.e., executable instructions) embodied in tangible media, such as floppy diskettes, CD-ROMs, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

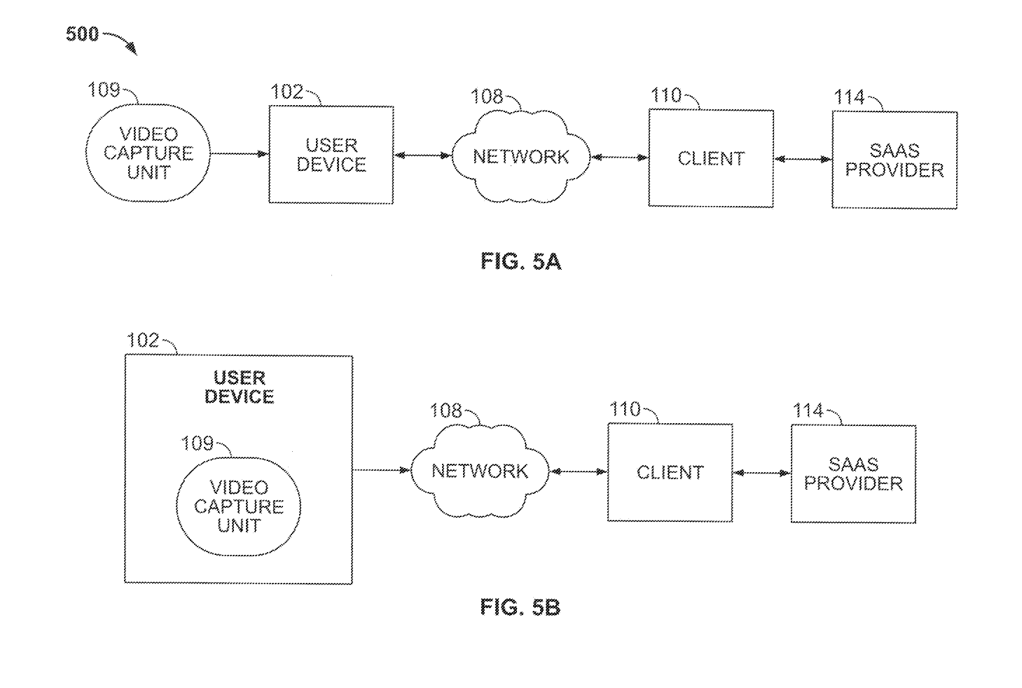

FIGS. 5a-5b illustrate a video system which a candidate may use to capture and record video. In FIG. 5a, a first embodiment of video system 500 includes video capture unit 109′ which is coupled to user device 102′. Video capture unit 109′ may include a desktop computer coupled to a webcam, a laptop computer coupled to a webcam, a video camera, a tablet device, a smartphone, a cellular phone, or an otherwise similar device. In FIG. 5b, a second embodiment of video system 500 includes video capture unit 109′ is embedded within user device 102′.

FIG. 6a depicts further details of step 324, wherein the candidate's written and video responses are shared amongst designated users. In step 600, one or more designated users are enabled to access integrated module 119′ (step 326). A designated user is an individual whom the administrator wishes to share the candidate's application information with. One or more designated users may enable user device 102′ to retrieve integrated module 119′ by accessing a hyperlink within an email which is sent to the one or more designated users by SAAS provider 114′. In a preferences setting, an administrator may provide the emails of one or more designated users who are to receive integrated module 119′.

In step 602, one or more designated users views integrated module 119′. As discussed above in FIG. 3f, when a user accesses integrated module 119′ with user device 102′, a user is enabled to view a graphical user interface of the candidate's written and video assessment, as well as any supplemental documents which may have been included by the candidate. Integrated module 119′ is an aggregation of all candidates who have entered the formal application process. Thus, the graphical user interface that a designated user accesses with user device 102′ in step 602, is a layout of multiple candidates for ease of comparison.

As illustrated in FIG. 6b, screenshot 60 shows that a user may compare and contrast candidates as they wish by using input device 106′ to click or select different aspects of the module. For example, a designated user may be in the process of viewing candidate video A, and after doing so, may directly view the test assessment results of candidate B. Display device 104′ enables one or more designated users to view the full contents of the electronic application submitted by the candidate which includes both questions and answers. In addition, display device 104′ enables one or more designated users to select “play” and view the video portion of integrated module 119′. As the playback video is streamed, one or more designated users may view the candidate using display device 104′, and hear the responses being spoken by the candidate using audio device 107′ which is coupled to user device 102′.

Next, in step 604, after having viewed the contents of integrated module 119′, a user may add comments and ratings for any or all candidates presented in integrated module 119′.

FIG. 6c illustrates a screen shot 62 of what a designated user will see when viewing details of a candidate's assessment. Block 64 details strengths, weaknesses, and red flags for a candidate. In addition, a summary of the person's overall style is provided in order to give the designated user an overview of the candidate. Block 66, gives the reviewer an “assessment at a glance” by providing a qualitative summary of the individual. Block 68, gives the reviewer a summation of the candidate by suggesting which areas the candidate is most likely to succeed. Block 67 enables the reviewer to assign a rating to the candidate, where a greater number of stars indicate a better or higher rating. Finally block 69 enables a reviewer to share the candidate profile. When a user selects or clicks the 69 button, a user is then prompted to provide a “destination email address” belonging to the individual who is to receive the full candidate profile. In addition, a reviewer may provide any desired comments or feedback on any or all candidates. In addition, a designated user is enabled to provide a numerical rating for each candidate (1 being an outstanding overall assessment; 10 being a poor overall assessment). In the comments section, a designated user may indicate why a particular candidate was assigned such a rating. In addition, a designated user may use the comment field to note follow-up questions that should be asked of the candidate. In step 606, any newly added information (from step 604) including comments, feedback, and ratings from the designated users are referred to as reviewer portal 28′. Reviewer portal 28′ is sent to SAAS provider 114′. The contents of reviewer portal 28′ are aggregated to integrated module 119′, resulting in integrated module 121′. Integrated module 121′ is then converted into a predetermined format which is suited for easy viewing within a single graphical user interface.

FIG. 6d illustrates an overview of integrated module 121′. Integrated module 121′ is a self-contained component which contains an aggregation of information specific to the reviewer portion of the application process. More specifically, the integrated module 121′ is comprised of a master web page created by a master jsp file. Within the master jsp file are smaller jsp files which are aggregated with the master web page to create the finished composite webpage which is visible to the user (FIG. 6c). Administrative portal 24′ and candidate portal 26′, represent both the administrator and candidate portals from integrated module 119′. Reviewer portal 28′ contains the comments, ratings, and feedback data from each reviewer. Each of the administrative portal 24′, candidate portal 26′, and reviewer portal 28′, belong to smaller jsp files. The combination of the three portals form a larger composite master jsp file, which is associated with a master web page. In step 606, an administrator accesses integrated module 121′ via client 110′. With user device 102′, an administrator is enabled to view integrated module 121′ as a single user interface using display device 104′. In step 608, a determination is made as to which candidate to extend an offer of employment to.

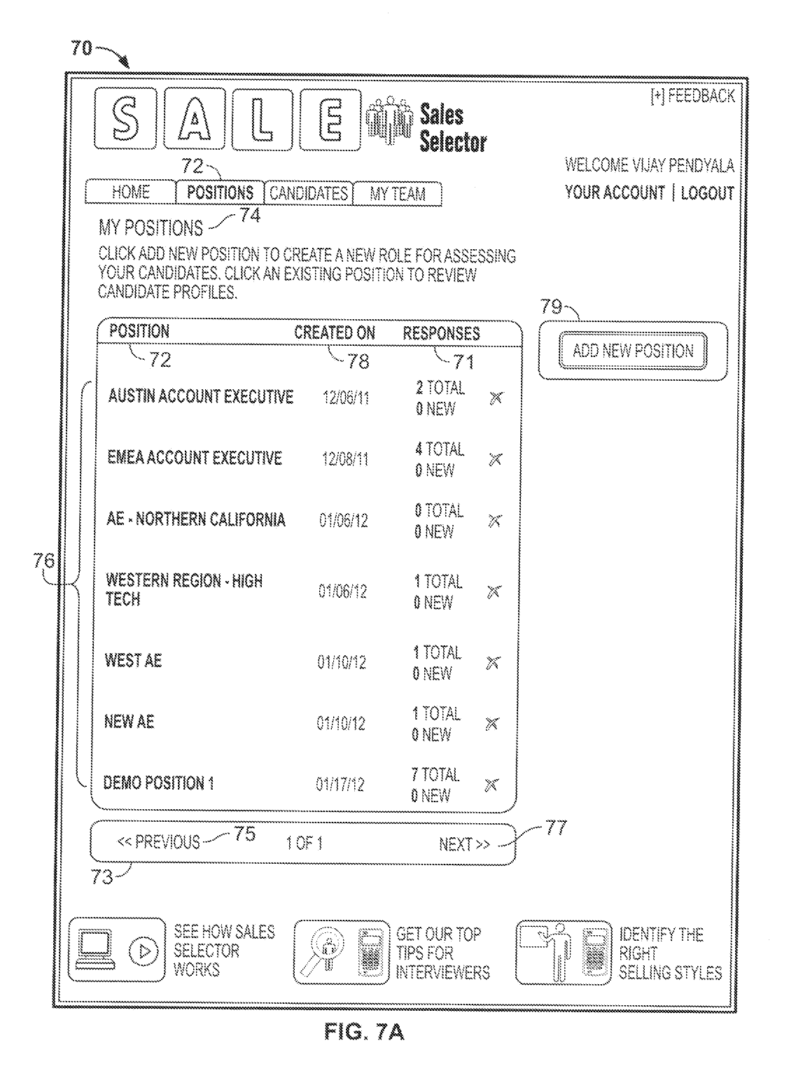

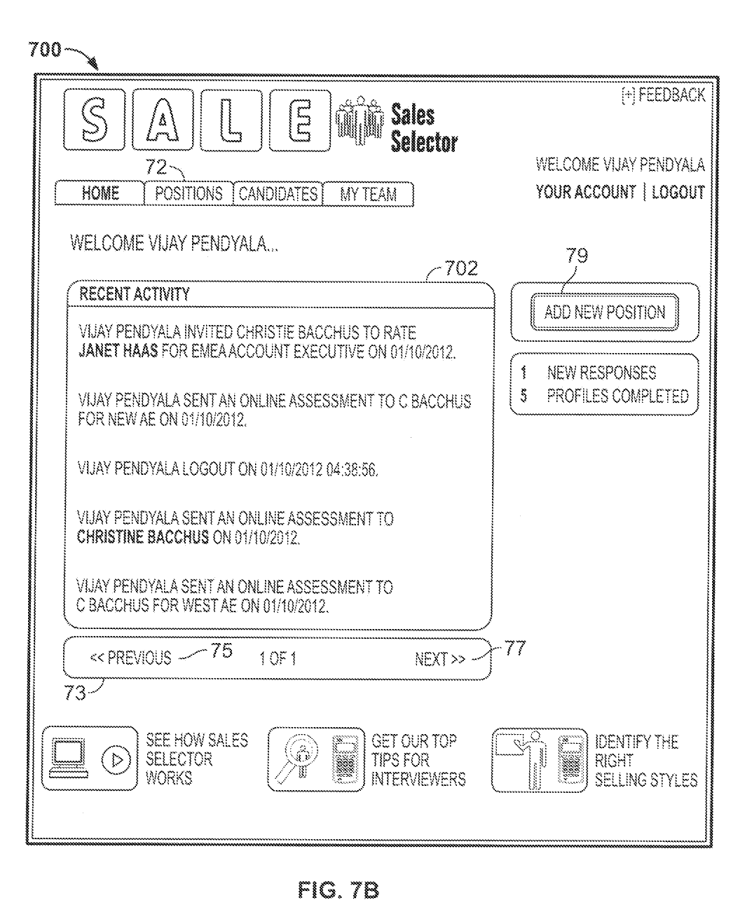

FIG. 7a is a screen shot 70 which further depicts step 200, a graphical user interface where an administrator creates a job posting. With user device 102′, a user is enabled to view screen shot 70 which is a graphical user interface of an assessment tool, viewable by display device 104′. To arrive at screen shot 70, a user must have successfully logged in from the homepage of the assessment tool by having entered in an acceptable username and passcode (as shown in FIG. 7b). After a successful login, a user may then select the tab 72 entitled “Positions”. By clicking or selecting the “Positions” tab, a hyperlink will then direct the user to screen shot 70. Within screen shot 70 is a frame 74 entitled “My Positions.” Within the “My Positions” field, a list of available job postings 76 as well as the date each position was posted (“created on” tab 78) and responses of reviewers (tab 71) are displayed. The administrator has the option of selecting a particular position by clicking on the title of any particular position in the list 76. By clicking on a particular position 76, an administrator will enable a hyperlink which will send them to an additional nested webpage which provides additional details of the selected position. Below frame 704 is another smaller frame 73, which enables an administrator to scroll from one page to another page within the assessment tool For example, if the “previous” tab 75 is selected or clicked, the administrator will advance to the homepage of the assessment tool. If the “next” tab 77 is selected or clicked, the designated user will advance to the Candidates page of the assessment tool. Adjacent frame 74 is another smaller frame 79 which enables a designated user to add a new position. If this tab is selected or clicked, a new position will be added to the already-existing list of job postings 76. In addition, new entries will appear in the corresponding “created on” tab 78 as well as the corresponding “responses” tab 71.

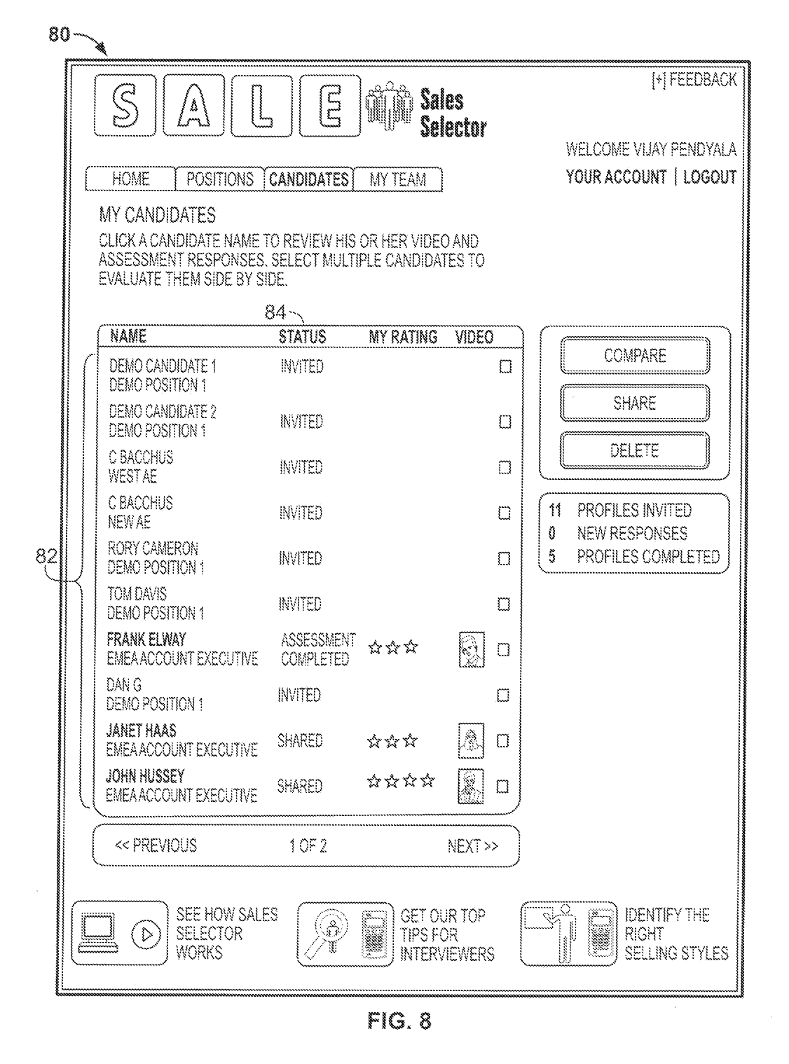

FIG. 8 depicts further details of step 224 as a screen shot 80 of an integrated module which designated users will view. Screen shot 800 shows a list of candidates in alphabetical order by last name 82. Adjacent the list of candidates is a column 84 depicting the status of each candidate. There are 3 available options to indicate the status. A status of “invited” indicates that a candidate 2 has successfully completed the pre-selection portion of the candidacy process and has been invited to continue their candidacy. A status of “assessment completed” indicates that a candidate has already begun the formal candidacy portion of the application process and has completed the written assessment portion of the application process. A status of “shared” indicates that a candidate has not only completed both the written and video assessments, and that a user has assigned a rating to the candidate and shared the candidate assessment package with another user. A user may share a candidate assessment package with another user by sending a notification email to the recipient-user. Embedded in the notification email is a hyperlink. When the recipient-user selects or clicks on the hyperlink, a new browser window containing the candidate assessment package 80 appears as a single graphical user interface on display device 104′ of user device 102′.

In an alternative embodiment of the present invention (not shown), a hiring manager (or other designated user) may consider previously unsuccessful candidates in order to address new hiring needs. As discussed above, when a candidate applies to a particular position, the formal candidacy process requires written and video responses to application questions, along with any optional supplemental documents (including resumes, cover letters, transcripts, recommendation letters) the candidate wishes to include with the application. Once the candidate's submission is complete, (as discussed in FIG. 6a), designated users who have access to the candidate's formal application package are enabled to review the package and provide feedback in the form of comments and ratings. However, in the event that a candidate completes the formal application process and does not receive an offer of employment, both the candidate data as well as the feedback provided by the designated users will remain in a designated online storage area until a future time when such information is needed again. For example, when a new position becomes available, the hiring manager for the new position may obtain complete access to both the candidate data as well as the feedback received from the designated users. In this instance, the hiring manager for the new position is free to browse the stored information of any and all former candidates in order to determine whether or not any previous applicants may be suitable for the newly created position. An advantage of browsing such stored candidate records is the ability to thoroughly consider prospective candidates based on their previous applications without the need for requiring a new application submission from the candidate, saving both time and effort of the candidate as well as the hiring manager.

Although the present invention has been described in accordance with the embodiments shown, it is not intended to be limited to the specific form set forth herein, but on the contrary, it is intended to cover such alternatives, modifications, and equivalents, as can be reasonably included within the spirit and scope of the invention as defined by the appended claims.

What is claimed is:

1. A method of assessing an applicant's candidacy using a web-based platform on a cloud-based server, to facilitate a remote interviewing process for the applicant for a position in an organization, comprising:
using a hosted application within the web-based platform so an administrator generates an initial set of position requirements for candidates to view, said hosted application further comprising:
providing a job description by said hosted application for a position for said candidates to review and provide appropriate responses thereto by questions being generated by said hosted application provided by the administrator using a graphical user interface (GUI) of said hosted application; and
combining by the hosted application multiple files including an uploaded video response file, and one or more reviewer files containing feedback, ratings, and response data into a first single frame of the GUI of the hosted application.

2. The method of claim 1, wherein each of the feedback, ratings, and responses are provided by one or more reviewers.

3. The method of claim 2, wherein one or more reviewers are users whom the administrator has selected to review the potential candidates, wherein the uploaded video response file contains a video file format of the candidate response.

4. The method of claim 1, wherein the one or more reviewer files contain feedback about the candidate video responses in the form of rating data.

5. The method of claim 1, further comprising:
aggregating the uploaded video response file of each candidate, together with each reviewer file into a second single frame of the GUI of the hosted application so that multiple job candidate each having individual second single frames which can be easily compared by the administrator and/or reviewers.

6. The method of claim 1, wherein the aggregating of the candidate's responses into the single frame of the GUI of the hosted application further comprises formatting the candidate's responses into consistent predetermined audio and visual formats.

7. The method of claim 1, further comprising:
accessing a database to obtain said questions, wherein said questions are determined pre-selection questions of a particular format type and used to identify those candidates who satisfy the minimum criteria to continue the candidacy process.

8. The method of claim 1, further comprising:
enabling responses uploaded by said candidate using any processing device coupled to a video camera with video capture capability, said processing device being capable of sending video to the hosted application using a software upload tool within the web-based platform.

9. The method of claim 4, wherein said processing device comprises a desktop computer, a laptop computer, a tablet device, a smartphone, or an otherwise like device having video capture and upload functionality.

10. A method of obtaining feedback about an applicant's candidacy using a web-based platform on a cloud-based server, to facilitate a remote interviewing process for the applicant for a position in an organization, comprising:
using a hosted application within the web-based platform so an administrator generates an initial set of position requirements for candidates to view, said hosted application further comprising:
providing a job description by said hosted application for a position for said candidates to review and provide appropriate responses thereto by questions being generated by said hosted application provided by the administrator using a graphical user interface (GUI) of said hosted application;
combining by the hosted application multiple files including an uploaded video response file, and one or ore reviewer files containing feedback, ratings, and response data into a first single frame of the GUI of the hosted application; and
allowing a plurality of reviewers selected by an administrator to receive permission to access the video candidacy information and provide feedback in a predetermined type format.

11. The method of claim 10, further comprising:
storing the predetermined formatted information at a hosted location accessible by the administrator.

12. The method of claim 11, further comprising:
accessing and arranging said predetermined formatted information in a manner such that each video candidacy information has attached the plurality of reviewer feedback therein and further arranged in a stacking configuration so that the reviewers can compare each of the candidates in a like manner.

13. The method of claim 10, wherein the feedback includes assigning a numerical rating which correlates to the overall favorability of the candidate.

14. The method of claim 13, further comprising:
comparing the numerical ratings by an administrator, enabling the administrator to determine which candidates to extend an offer of employment to.

15. A system for evaluating an applicant comprising:
a web-based platform on a cloud-based server; and
a hosted application within the web-based platform.

16. The system of claim 15 wherein a job description is provided by said hosted application for candidates to review and provide appropriate responses thereto by questions which are generated by said hosted application provided by the administrator using a graphical interface of said hosted application.

17. The system of claim 15 wherein said hosted application is combined with multiple files including an uploaded video response file, and one or more reviewer files containing feedback, ratings, and response data into a single frame of the GUI of the hosted application.

18. The system of claim 15 wherein the plurality of evaluators access applicant data from the database, and provide an assessment of an applicant based on the applicant data.

19. The system of claim 18 wherein the ratings from the plurality of evaluators are compared.

20. The system of claim 18 wherein the plurality of evaluators provide a rating based on the applicant data.
